(19) United States
(12) Patent Application Publication
(10) Pub. No.: US 2025/0346445 A1
(43) Pub. Date: Nov. 13, 2025

(54) LINEAR TRANSPORT SYSTEM

(71) Applicant: Beckhoff Automation GmbH, Verl (DE)

(72) Inventors: Jan Achterberg, Duisburg (DE); Manuel Bettenworth, Wien (AT)

(21) Appl. No.: 19/270,706

(22) Filed: Jul. 16, 2025

Related U.S. Application Data
(63) Continuation of application No. PCT/EP2024/050463, filed on Jan. 10, 2024.

(30) Foreign Application Priority Data
Jan. 17, 2023 (DE) 10 2023 101 107.4

(51) Int. Cl. B65G 54/02; B65G 43/00

(52) U.S. Cl. CPC B65G 54/02; B65G 43/00; B65G 2203/043

(57) ABSTRACT

A linear transport system includes a movable unit, a guide rail and a linear motor with a stator and a rotor for driving the movable unit along the guide rail. The stator has a plurality of motor modules arranged along the guide rail, each with a plurality of drive coils. The rotor is arranged on the movable unit and includes a plurality of magnets. A gap is arranged between at least two of the motor modules. The motor module length corresponds to the distance between two drive coil centers multiplied by the number of drive coils per motor module. The rotor length corresponds to the distance between two magnet centers multiplied by the number of magnets on the rotor. The gap length corresponds at least to the motor module length, and the rotor length corresponds at least to the sum of the motor module length and the gap length.

### CROSS-REFERENCE TO RELATED APPLICATIONS

This patent application is a continuation of International patent Application PCT/EP2024/050463, filed Jan. 10, 2024, entitled “Linear Transport System,” which claims the priority of German patent application DE 10 2023 101 017.4, filed Jan. 17, 2023, entitled “Lineares Transportsystem,” each of which is incorporated by reference herein, in the entirety and for all purposes.

### FIELD

The invention relates to a linear transport system.

### BACKGROUND

Linear transport systems are known from the state of the art. For example, publication DE 10 2012 204 919 A1 discloses a linear transport system having a movable unit, a guide rail for guiding the movable unit, and a linear motor for driving the movable unit along the guide rail, where the linear motor comprises a stator and a rotor, where the stator comprises a plurality of motor modules arranged in a stationary manner along the guide rail, each of which comprises a plurality of drive coils, where the rotor is arranged on the movable unit and comprises a plurality of magnets.

Such a linear transport system comprises motor modules along the guide rail, where the entire guide rail is equipped with motor modules arranged on it, each directly adjacent to the other. This requires a large number of motor modules, making the design of this linear transport system costly and resource-intensive. This is particularly the case with long linear transport systems.

### SUMMARY

The invention to provides a more cost-effective and resource-saving linear transport system.

According to a first aspect, a linear transport system comprises a movable unit, a guide rail for guiding the movable unit and a linear motor for driving the movable unit along the guide rail. The linear motor comprises a stator and a rotor, the stator comprising a plurality of motor modules which are arranged in a stationary manner along the guide rail and each comprise a plurality of drive coils, the rotor being arranged on the movable unit and comprising a plurality of magnets, the motor modules having a motor module length, the motor module length corresponding to a distance between two drive coil centers multiplied by a number of drive coils per motor module, the rotor having a rotor length, the rotor length corresponding to a distance between two magnet centers multiplied by a number of magnets of the rotor.

A gap is arranged between at least two of the motor modules, the gap having a gap length. The rotor length corresponds at least to the sum of the motor module length and the gap length. The gap length corresponds at least to the motor module length.

According to a second aspect, a linear transport system linear transport system comprises a movable unit, a guide rail for guiding the movable unit, a linear motor for driving the movable unit along the guide rail and a controller. The linear motor comprises a stator and a rotor, the stator comprising a plurality of motor modules which are arranged in a stationary manner along the guide rail and each comprise a plurality of drive coils, the rotor being arranged on the movable unit and comprising a plurality of magnets.

A gap is arranged between at least two of the motor modules, the gap having a gap length, and where the controller is set up to issue control commands to the motor modules and the motor modules are set up to energize the drive coils on the basis of the control commands. The controller issues control commands so that the movable unit carries out a predetermined movement along the guide rail and where the controller recognizes installation-related deviations in gap length on the basis of the predetermined movement takes them into account for the output of further control commands.

According to a third aspect, a linear transport system comprises a movable unit, a guide rail for guiding the movable unit and a linear motor for driving the movable unit along the guide rail. The linear motor comprises a stator and a rotor, the stator comprising a plurality of motor modules which are arranged in a stationary manner along the guide rail and each comprise a plurality of drive coils, the rotor being arranged on the movable unit and comprising a plurality of magnets, the motor modules having a motor module length, the motor module length corresponding to a distance between two drive coil centers multiplied by a number of drive coils per motor module, the rotor having a rotor length, the rotor length corresponding to a distance between two magnet centers multiplied by a number of magnets of the rotor.

A gap is arranged between at least two of the motor modules, the gap having a gap length. The rotor length corresponds at least to the sum of the motor module length and the gap length. In a first region the gap is a first gap and the gap length is a first gap length, where a second gap is arranged in a second region between two of the motor modules, where the second gap has a second gap length, where the first gap length and the second gap length differ from each other.

### EXAMPLES

In an embodiment, a linear transport system comprises a movable unit, a guide rail for guiding the movable unit and a linear motor for driving the movable unit along the guide rail. The linear motor comprises a stator and at least one rotor. The stator comprises a plurality of motor modules arranged in a stationary manner along the guide rail, each of which comprise a plurality of drive coils. The rotor is arranged on the moving unit and comprises a plurality of magnets.

A gap is formed between at least two of the motor modules. The motor modules comprise a motor module length that corresponds to a distance between two drive coil centers multiplied by a number of drive coils per motor module. Small deviations may occur here, as well, so that installation tolerances may e.g. be compensated for.

The rotor comprises a rotor length that corresponds to a distance between two magnet centers multiplied by the number of magnets in the rotor. Small deviations may also occur here, for example due to additional radii. In particular, the distances may be related to one another and, apart from minor deviations that are possible due to installation, the specified relations may be maintained.

The gap comprises a gap length. The rotor length corresponds to n times the sum of the motor module length and the gap length

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a side view of a linear transport system.

FIG. 2 shows a further side view of the linear transport system of FIG. 1.

FIG. 3 shows a cross-section of the linear transport system of FIG. 1.

FIG. 4 shows a schematic top view of a stator and of a rotor of the linear transport system of FIGS. 1 to 3.

FIG. 5 shows schematic depictions of the stator and of the rotor of the linear transport system of FIGS. 1 to 4 for different rotor positions.

FIG. 6 shows a side view of a further linear transport system.

FIG. 7 shows a cross-section of the linear transport system of FIG. 6.

FIG. 8 shows a position magnet element.

FIG. 9 shows another position magnet element.

FIG. 10 shows another position magnet element.

FIG. 11 shows a schematic depiction of a stator and of a rotor of a further linear transport system.

FIG. 12 shows a side view of a further linear transport system.

FIG. 13 shows a schematic depiction of a stator and a rotor of a further linear transport system.

FIG. 14 shows a schematic depiction of a stator and a of rotor of a further linear transport system.

FIG. 15 shows a schematic depiction of a stator and of a rotor of a further linear transport system.

FIG. 16 shows a schematic depiction of a side view of a stator and of a rotor of a further linear transport system.

FIG. 17 shows a further side view of the linear transport system of FIG. 16.

FIG. 18 shows a schematic depiction of a stator and of a rotor of a further linear transport system.

FIG. 19 shows a schematic depiction of a stator and of a rotor of a further linear transport system.

### DETAILED DESCRIPTION

In the following, the same reference numerals may be used for elements that have the same effect. As the case may be, these elements are not described again for each figure. Nevertheless, said elements having the same effect may be provided accordingly in all embodiments.

In particular, the rotor length may be referred to as L_{L}, the motor module length as L_{M} and the gap length as L_{S}. The rotor length L_{L} may then be calculated using the formula:

$${L}_{L} = n ( {L}_{M} + {L}_{S} ) .$$

In this case, the factor n is a natural number. The term n-fold therefore also particularly includes that the rotor length corresponds to the sum of the motor module length and the gap length. The term n-fold is used synonymously with the term multiple. The rotor and thus the moving unit, as well, may be driven, for example, by energizing the drive coils and a magnetic drive field generated thereby interacting with the magnets of the rotor.

It is possible that the linear transport system comprises a plurality of moving units, each of which comprises such a rotor as part of the linear motor. The moving units and/or the rotors may have an identical embodiment.

The distance between two drive coil centers may be referred to as the drive coil length. The gap length may be at least twice the drive coil length, in particular at least three times the drive coil length. The motor module length may then be a multiple of the drive coil length. In particular, the motor module length may be a multiple of three times the drive coil length. The magnets of the rotor may have a magnet length, where the magnet length corresponds to a distance between two centers of the magnets. The motor module length may be a multiple of four times the magnet length. In particular, four times the magnet length may correspond to three times the drive coil length. It may also be provided that the distance between two drive coil centers is not equal to the distance between two magnet centers.

In an embodiment, the number of magnets in the rotor is a multiple of four. The number of drive coils per motor module is a multiple of three. Alternatively, it may also be provided that the number of magnets of the rotor is a multiple of five and the number of drive coils per motor module is a multiple of three. Alternatively, it may also be provided that the number of magnets of the rotor is a multiple of seven and the number of drive coils per motor module is a multiple of six.

In an embodiment, the gap length corresponds to at least the motor module length. In this case, at least every second motor module may be saved compared to a conventional linear transport system. This results in cost savings and resource savings.

In an embodiment, the gap length is a multiple of the motor module length. In particular, the gap length may correspond to the motor module length, twice the motor module length or three times the motor module length. In these cases, only half, a third or a quarter of the motor modules are required compared to a conventional linear transport system.

In an embodiment, the gap in a first area is a first gap and the gap length is a first gap length. In a second area between two of the motor modules, a second gap is embodied. The second gap comprises a second gap length. The first gap length and the second gap length differ from each other. This makes it possible, for example, for different drive magnetic fields to be generated in the first area and in the second area, which may differ in particular in terms of magnetic field strength. As a result, a linear transport system may be provided in which, for example, an increased drive magnetic field may be provided in the second area compared to the first area. The first area may then be suitable for transportation, for example, and the drive magnetic field in the first area may be sufficient for transportation, while in the second area, processing of an object arranged on the moving unit requires an increased drive magnetic field. With the aid of this embodiment, motor modules may still be saved and an increased drive magnetic field may still be provided in partial areas of the linear transport system.

In an embodiment, the first gap length corresponds to n times the motor module length. The second gap length corresponds to n times the motor module length reduced by one. For example, the first gap length may correspond to three times the motor module length and the second gap length may correspond to twice the motor module length. In an embodiment, the first gap length corresponds to n times the motor module length. The second gap length corresponds to n times the motor module length reduced by two. This results in savings in the number of motor modules with a simultaneous increase in the drive magnetic fields in the second area.

In an embodiment, the first gap length corresponds to three times the motor module length. The second gap length corresponds to the motor module length. In particular, this means that the first gap length provided in the first area may initially also be provided in the second area when setting up the linear transport system and then a further motor module is placed in the middle of the first gap in the second area so that the second gap length is embodied. In this way, a simple structure of the linear transport system may be achieved.

In an embodiment, the magnets of the rotor are arranged in two magnetic elements. The magnetic elements each comprise a plurality of magnets. The rotor length is a sum of the magnetic element lengths of the magnetic elements. The magnetic elements are arranged at a distance from one another. In particular, an intermediate area without magnets of the rotor is therefore embodied between the magnetic elements. It may be provided that a distance between the magnetic elements corresponds to the magnet length. The lengths of the magnetic elements may, for example, correspond to half the length of the magnet. This means that the magnets may be divided up between two magnetic elements. As the case may be, an improved position determination for the rotor or the movable unit may be achieved with the aid of this arrangement.

In an embodiment, the drive coils of the motor modules are energized in such a way that a force acts upon at least one magnet of one of the magnetic elements of the rotor. This allows for the rotor to be continuously driven.

In an embodiment, a plurality of drive coils of different motor modules may be energized simultaneously in order to generate a force upon the magnetic elements of the rotor. This allows for a more flexible drive of the rotor.

In an embodiment, the motor modules are arranged in motor module elements. The motor module elements also comprise a magnetic sensor element. A magnetic field of the rotor may be measured with the aid of the magnetic sensor element and a rotor position may be determined from this. A position of the moving unit is also known from the determined rotor position and it may be possible to energize the drive coils based on the position of the rotor or the rotor position in order to provide a drive force.

In an embodiment, the magnetic sensor element comprises a magnetic sensor element length. The magnetic sensor element length is larger than the motor module length. Magnetic sensors are often cheaper to manufacture than drive coils. In contrast to a conventional linear transport system, a gap is provided in the linear transport system according to the invention in which no motor modules are arranged. However, it may be possible to arrange additional magnetic sensors there, so that the length of the magnetic sensor element is larger than the length of the motor module. A sensor gap may also be provided between the magnetic sensors, but this gap is smaller than the gap between the motor modules. This arrangement ensures that every possible rotor position may be clearly determined.

In an embodiment, the magnetic sensor element may be used to measure a magnetic field of the magnets of the rotor. In an embodiment, a magnetic field of position magnets of the moving unit may be measured with the aid of the magnetic sensor element. The rotor position may therefore be determined via the magnets used to drive the rotor and/or via additionally attached position magnets. In particular, the position magnets may have a lower magnetic field strength than the magnets.

In an embodiment, the magnets of the rotor comprise different extensions in a direction perpendicular to the guide rail. Conclusions may be drawn about the rotor position based on the different extension of the magnets. This makes it easy to determine the position, the accuracy of which is increased by the different extensions perpendicular to the guide rail.

In an embodiment, the magnets have a different relative position to the magnetic sensor element, for example a different overlap with the magnetic sensor element, due to the different extensions perpendicular to the guide rail. This increases the accuracy of the position determination.

In an embodiment, the position magnets of the movable unit comprise different magnetic field strengths. This embodiment may also increase the accuracy of the position determination, since the magnetic fields of the position magnets differ from one another.

In an embodiment, the position magnets comprise a different magnetic field strength at a front end and at a rear end of the movable unit, viewed with regard to a direction of movement, than between the front end and the rear end of the movable unit. This makes it possible to detect the front end or the rear end of the movable unit with the aid of the magnetic sensor element. The front end or rear end therefore relate to a direction of movement of the movable unit.

In an embodiment, the linear transport system comprises a controller. The controller is set up to issue control commands to the motor modules. The motor modules are set up to energize the drive coils based on the control commands.

In an embodiment, the controller is set up to output the control commands in such a way that a movable unit carries out a predefined movement along the guide rail. The controller is also set up to use the specified movement to detect installation-related deviations in gap lengths and to take them into account when issuing further control commands.

In particular, the controller may be set up to detect a ratio of sensor signals from different magnetic sensors in different motor modules and thus recognize and take into account the installation-related deviations. This may be achieved by the sensor signals having different ratios with regard to one another in the event of installation-related deviations in gap lengths.

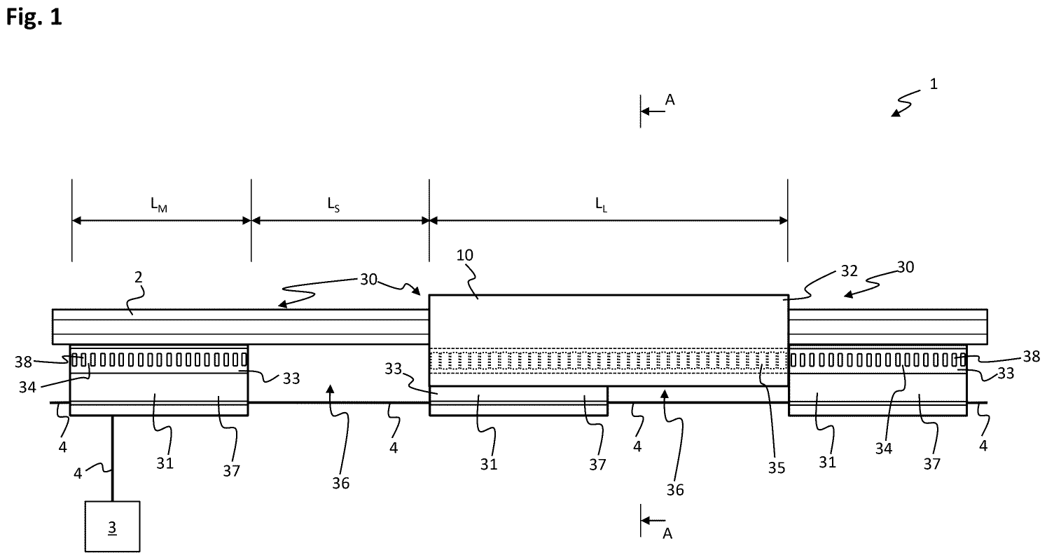

FIG. 1 shows a side view of a linear transport system 1. The linear transport system 1 comprises a movable unit 10, a guide rail 2 for guiding the movable unit 10 and a linear motor 30 for driving the movable unit 10 along the guide rail 2.

The linear motor 30 comprises a stator 31 and a rotor 32. The stator 31 comprises a plurality of motor modules 33 arranged in a stationary manner along the guide rail 2, each of which comprises a plurality of drive coils 34. The stator 31 therefore consists of a plurality of motor modules 33. Three motor modules 33 are shown as an example.

The rotor 32 is arranged on the movable unit 10 and comprises a plurality of magnets 35. The rotor 32 is thus part of the movable unit 10, which may have other components not belonging to the rotor 32, such as rollers for rolling on the guide rail 2.

One of the motor modules 33 is covered by the rotor 32 or by the movable unit 10. A gap 36 is formed between each of the three motor modules 33 shown. Accordingly, the motor modules 33 are arranged at a distance from one another.

In FIG. 1, the motor modules 33 are each arranged in a motor module element 37. In addition to the motor modules 33, the motor module elements 37 may comprise further components such as, for example, position sensors and/or a shared housing and/or control electronics for controlling the drive coils 34 of the motor modules 33.

The motor modules 33 each have a motor module length L_{M}. The rotor 32 has a rotor length L_{L}. The gap 36 has a gap length L_{S}. The rotor length L_{L} corresponds to n times the sum of the motor module length L_{M} and the gap length L_{S}. In particular, the rotor length L_{L} may therefore be calculated using the formula:

$${L}_{L} = n ( {L}_{M} + {L}_{S} ) ,$$

where n is a natural number.

The term n-fold therefore also particularly includes that the rotor length corresponds to the sum of the motor module length and the gap length. The rotor 32 and thus the movable unit 10, as well, may be driven, for example, by energizing the drive coils 34 and a magnetic drive field generated as a result interacting with the magnets 35 of the rotor 32. Optionally, FIG. 1 shows stator teeth 38 of the motor modules 33. Each second stator tooth 38 is wrapped by a drive coil 34 and thus serves as a coil core for the respective drive coil 34. The stator teeth 38 may consist of a ferromagnetic material. Energizing the drive coils 34 may lead to an amplification of the drive magnetic field by the stator teeth 38.

It is possible that the linear transport system 1 comprises a plurality of movable units 10, each of which comprises such a rotor 32 as part of the linear motor 30, although only one movable unit 10 is shown in FIG. 1. The moving units 10 and/or the rotors 32 may have an identical design.

It may be provided that the motor module elements 37 are able to detect positions of the rotor 32, for example via sensors in various embodiments. It is also possible to provide external position sensors. The relationships described herein may be independent of how a rotor position is determined.

In the example embodiment shown in FIG. 1, the gap length Ls corresponds to the motor module length L_{M}. It may be provided that the gap length L_{S} corresponds at least to the motor module length L_{M}. In this case, at least every second motor module 33 may be omitted compared to a conventional linear transport system 1. In a conventional linear transport system, further motor module elements 37 would be arranged instead of the gaps 36, thus creating a continuous stator 31. The arrangement of the motor modules 33 as shown in FIG. 1 results in cost savings and resource savings.

FIG. 1 also shows that the linear transport system 1 comprises a controller 3, which is connected to one of the motor module elements 37 with the aid of a data line 4. The motor module elements 37 are also connected to one another via a data line 4. In particular, communication between the controller 3 and the motor module elements 37 may take place via a data bus, for example a field bus, where the data bus may be provided via the data lines 4.

In particular, the controller 3 may be an active subscriber and provide the data bus, while the motor module elements 37 may be passive subscribers that are addressed with the aid of the data bus. As the case may be, it may also be provided that each of the motor module elements 37 is directly connected to the controller 3. Furthermore, the data lines 4 may also provide a current and/or voltage supply to the motor module elements 37. As an alternative, it is possible to use additional lines, for the current and/or voltage supply.

The controller 3 may be set up to issue control commands to the motor modules 33. The motor modules 33 may be set up to energize the drive coils 34 on the basis of the control commands. The controller 3 may also be set up to output the control commands in such a way that a movable unit 10 carries out a predetermined movement along the guide rail 1, to recognize installation-related deviations in gap lengths Ls on the basis of the predetermined movement and to take them into account for the output of further control commands.

Stationary (position) sensors, such as Hall sensors, may be installed in the motor module units 37. When a magnet or a position magnet is moved over the Hall sensor, this results in a signal curve for said Hall sensor. The positions of the rotor 32 or the moving unit 10 may be calculated from the signal curves of a plurality of such Hall sensors. If a signal curve or a plurality of signal curves of different motor module units 37 are compared, differences to the theoretical target curve may indicate installation-related deviations in gap lengths L_{S}.

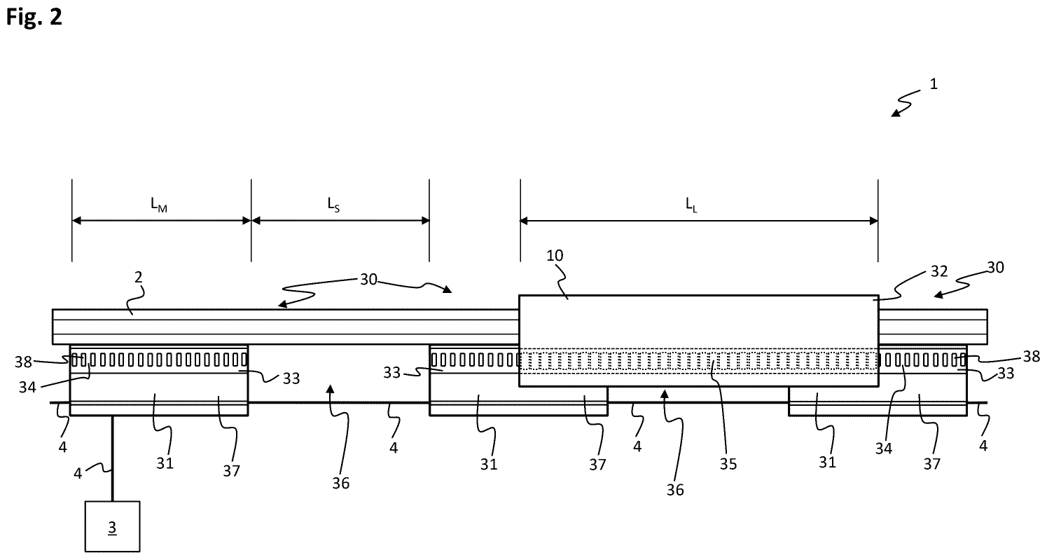

FIG. 2 also shows the linear transport system 1 of FIG. 1. Unless differences are described below, the description of the transport system 1 of FIG. 1 also applies to the transport system 1 of FIG. 2.

In contrast to the depiction in FIG. 1, the movable unit 10 or the rotor 32 has been moved along the guide rail with the aid of energized drive coils 34 of the middle and right-hand motor modules 33 and stators 31 shown in such a way that the movable unit 10 is now partially located above the middle motor module 33, above the gap 36 between the middle and right-hand motor modules 33 and partially above the right-hand motor module.

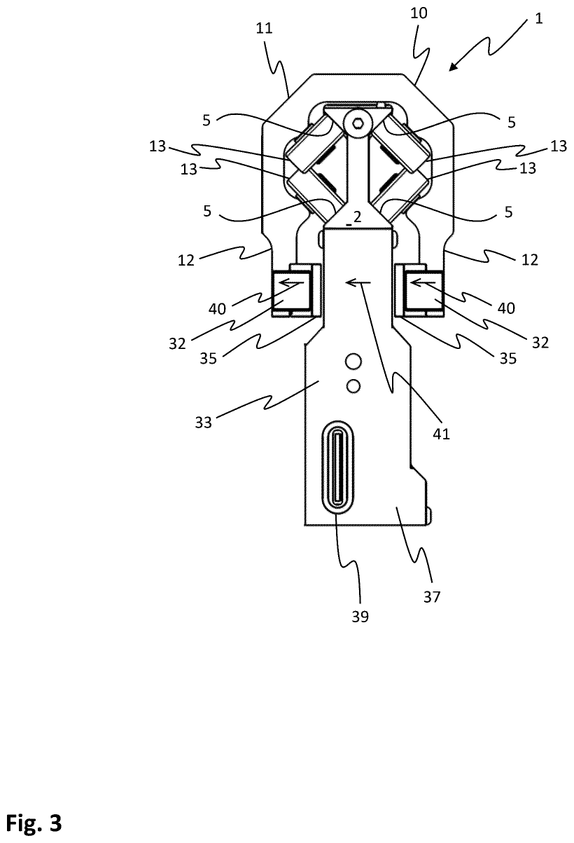

FIG. 3 shows a cross-section through the linear transport system 1 of FIG. 1 at the sectional plane marked A-A in FIG. 1. This is arranged in the area of one of the gaps 36, so that a cross-section of the movable unit 10 and the guide rail 2 as well as a side view of the motor module elements 37 is visible in FIG. 3. The motor module element 37 comprises a connection 39 for the data line 4. A current and/or voltage supply to the motor module element 37 may also be achieved via the connection 39. Alternatively, the motor module element 37 may have a connection for a current and/or voltage supply.

The movable unit 10 comprises a base body 11 that surrounds the guide rail 2 in a substantially U-shaped manner. The magnets 35 of the rotor 32 are arranged on the legs 12 of the base body 11, where the magnets 35 are arranged at the level of the stator teeth and drive coils of the motor module element 37. Furthermore, the movable unit 10 comprises rollers 13, which are supported against running surfaces 5 of the guide rail 2 and hold the movable unit 10 relative to the guide rail 2.

The magnets 35 of the rotor 32 are arranged on both sides of the motor module elements 37, so that interaction with magnetic fields of the drive coils 34 is possible. In particular, it may be provided that a direction of a magnetic field 40 of the magnets 35 is parallel or antiparallel to a coil magnetic field 41. The coil magnetic field 41 may be generated by the drive coils 34. The magnets 35 may be permanent magnets. This particularly allows for the rotor 32 to operate completely without moving parts and, in particular, without elements to be energized and for the rotor 32 or the movable unit 10 to be driven completely by energizing the drive coils 34.

In contrast to the illustration of FIGS. 1 to 3, the guide rail 2 may also be arranged differently on the motor module elements 37, resulting in a different configuration of rollers 13, base body 11 and arrangement of the stator 31 relative to the rotor 32. What is relevant for the present invention is not the relative arrangement of guide rail 2, motor module elements 37, rollers 13, base body 11 and arrangement of the stator 31 relative to the rotor 32, but the relation of rotor length L_{L}, motor module length L_{M} and gap length L_{S} as described above.

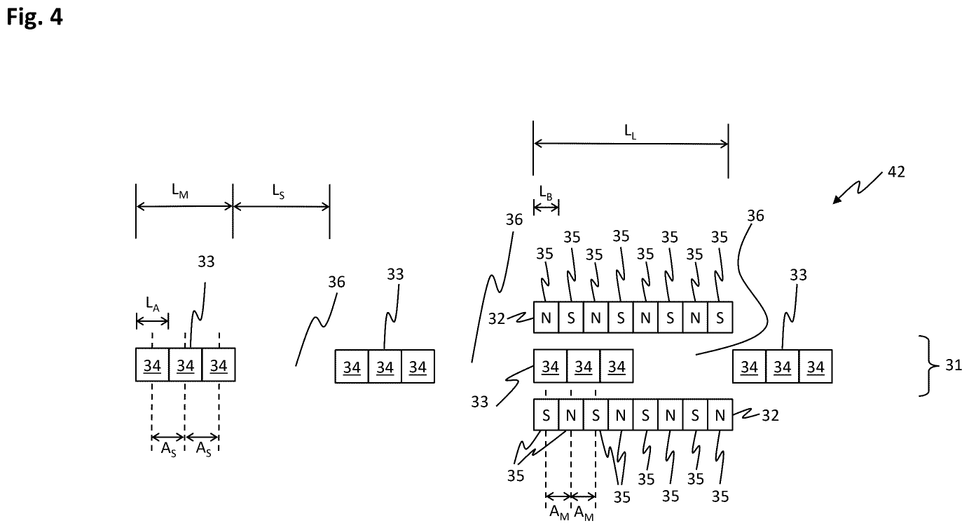

FIG. 4 shows a very simplified linear motor diagram 42 of the linear motor 30 of the linear transport system 1 of FIGS. 1 to 3 in a top view. Four motor modules 33 are shown here in FIG. 4 as examples, each containing three drive coils 34. The drive coils 34 may each comprise stator teeth 38, which then serve as coil cores. Further stator teeth 38 may also be arranged between the individual drive coils 34. Thus, unwound stator teeth 38 and stator teeth 38 wound with a drive coil 34 may alternate in a regular arrangement.

In particular, the number of drive coils 34 per motor module 33 may be a multiple of three. For example, there may be three, six, nine, twelve, etc. Drive coils 34 may be arranged per motor module 33. The drive coils 34 may be arranged in such a way that a drive magnetic field is essentially embodied vertically in the depiction of FIG. 4, i.e. that a magnetic field vector of the drive magnetic field has a larger component upwards or downwards in the depiction of FIG. 4 than in other directions.

The magnets 35 of the rotor 32 are arranged on both sides of the motor modules 33. An N or an S indicates which pole of the magnet 35 faces the motor modules 33. The magnets 35 are arranged along the motor modules 33 in such a way that a magnet 35 with an N pole facing the motor module 33 is opposite to a magnet 35 with an S pole facing the motor module 33.

In an example embodiment, the number of magnets 35 of the rotor 32 is a multiple of four. As an example, FIG. 4 shows that the rotor 32 comprises eight magnets 35 on each side, which alternately face the motor module 35 with their N-pole and S-pole. Alternatively, it may also be provided that the number of magnets 35 of the rotor 32 is a multiple of five and the number of drive coils 34 per motor module 33 is a multiple of three. As an alternative, it may also be provided that the number of magnets 35 of the rotor 32 is a multiple of seven and the number of drive coils 34 per motor module 33 is a multiple of six.

In an alternative example embodiment, it may be provided that the rotor 32 with the magnets 35 is only arranged on one side of the motor modules 35. In this case, too, the polarity of the magnets 35 may alternate as shown in FIG. 4, i.e. an N-pole and an S-pole may alternately face the motor module 33.

As shown in FIG. 4, the drive coils 34 have a distance A_{S} between their drive coil centers. The motor module length L_{M} may then correspond to the distance A_{S} between two drive coil centers multiplied by a number of drive coils 34 per motor module 33. For the embodiment of FIG. 4, the motor module length L_{M} e.g. corresponds to three times the distance A_{S} between two drive coil centers. The magnets 35 of the rotor 32 may also have a distance A_{M} between two magnet centers. The rotor length L_{L} then corresponds to the distance A_{M} between two magnet centers multiplied by a number of magnets 35 of the rotor 32, i.e. for the embodiment according to FIG. 4 eight times the distance A_{M} between two magnet centers. It may be provided that the distance A_{S}between two drive coil centers is not equal to the distance A_{M} between two magnet centers.

In a further alternative example embodiment, a linear magnetic field sensor arrangement may be provided arranged in parallel to the drive magnets 35 in a one-sided drive magnet arrangement in the direction of travel of the movable unit 10. In particular, the magnetic field sensors may be arranged on a printed circuit board. It may also be intended to provide motor module elements with a higher density of magnetic field sensors in order to achieve improved accuracy in determining the position of the movable unit 10 in certain applications.

The distance A_{S} between two drive coil centers may also be referred to as drive coil length L_{A}. The gap length L_{S} may correspond to at least twice the drive coil length L_{A}, in particular at least three times the drive coil length L_{A}. The motor module length L_{M} may then be a multiple of the drive coil length L_{A}. In particular, the motor module length L_{M} may be a multiple of three times the drive coil length L_{A}. The magnets 35 of the rotor 32 may have a magnet length L_{B}, where the magnet length L_{B} corresponds to a distance A_{M} between two centers of the magnets 35. The motor module length L_{M} may be a multiple of four times the magnet length L_{B}. In particular, four times the magnet length L_{B} may correspond to three times the drive coil length L_{A}. Furthermore, the combinations mentioned above may also be provided.

If the gap length L_{S} corresponds to at least the motor module length L_{M}, as shown in FIGS. 1, 2 and 4, at least every second motor module 33 or motor module element 37 may be saved compared to a conventional linear transport system 1. This results in cost savings and resource savings.

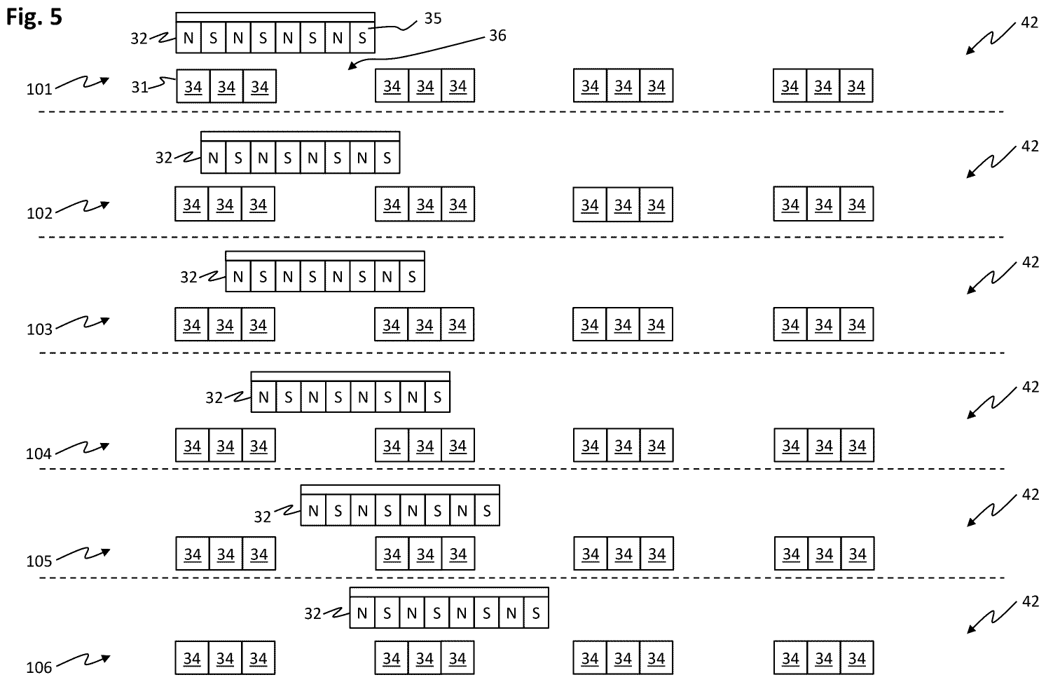

FIG. 5 shows a first view 101 of a linear motor diagram 42 of the linear motor 30 of the linear transport system 1 of FIGS. 1 to 4 from the top. For reasons of clarity, only one side of the rotor 32 in conjunction with the stators 31 is shown in FIG. 5. Of course, the structure shown in FIG. 5 may also be configured with magnets 35 of the rotor 32 embodied on both sides of the stators 31, analogous to the illustration in FIGS. 1 to 4.

The rotor 32 comprising the magnets 35 is arranged in such a way that it is flush with one of the motor modules 33 on the left-hand side in the first view 101. The motor module 33 and the magnets 35 are constructed as described in connection with FIG. 4. Here, four magnets 35 are located above the corresponding motor module 33 and four magnets 35 are located above the gap 36.

FIG. 5 also shows a second view 102 of the linear motor diagram 42 of the linear motor 30 of the linear transport system 1, in which the rotor 32 has been moved to the right by one magnet length L_{B}. In the second view 102, four magnets 35 are also arranged above motor modules 33 and four magnets 35 are located above the gap 36, however, here three magnets 35 are arranged above one of the motor modules 33 and one magnet 35 is arranged above another motor module 33, with the gap 36 being located between these motor modules 33.

By energizing the drive coils 34, four magnets 35 are thus arranged above motor modules 33 both in the first view 101 and in the second view 102 and four magnets 35 are arranged above a gap 36. In this manner, a constant drive force or, if applicable, an approximately constant drive force may also be provided during movement of the rotor 32 and thus of the movable unit 10.

FIG. 5 also shows a third view 103 and a fourth view 104 of the linear motor diagram 42 of the linear motor 30 of the linear transport system 1, in each of which the rotor 32 has been moved to the right by a further magnet length L_{B}. In these cases, as well, four magnets 35 are arranged above the motor modules 33 and four magnets 35 are arranged above a gap 36. FIG. 5 also shows a fifth view 105 and a sixth view 106 of the linear motor diagram 42 of the linear motor 30 of the linear transport system 1, in each of which the rotor 32 has been moved to the right by two further magnet lengths L_{B}. In these cases, too, four magnets 35 are arranged above the motor modules 33 and four magnets 35 are arranged above a gap 36.

It may be provided that the motor modules 33 or the motor module elements 37 comprise magnetic field sensors with the aid of which the magnetic field 40 of the magnets 35 may be used to determine the position of the rotor 32. The positions shown in the fifth view 105 and the sixth view 106 may be problematic, particularly because these two positions cannot be distinguished by the magnetic field sensors. Advantageous embodiments for solving this problem are described below. In principle, however, it may also be provided that the controller 3 may distinguish a position of the rotor 32 in the fifth view 105 and the sixth view 106 in that the information about the energization of the drive coils 34 indicates whether the rotor 32 is in the position of the fifth view 105 or in the position of the sixth view 106.

It may therefore particularly be provided that the motor modules 33 or the motor module elements 37 also comprise a magnetic sensor element and a magnetic field 40 of the rotor 32 may be measured with the aid of the magnetic sensor element and a rotor position may be determined from this. A position of the movable unit 10 is also known from the determined rotor position and it may be intended to energize the drive coils 34 on the basis of the position of the rotor 32 or the rotor position in order to provide a drive force.

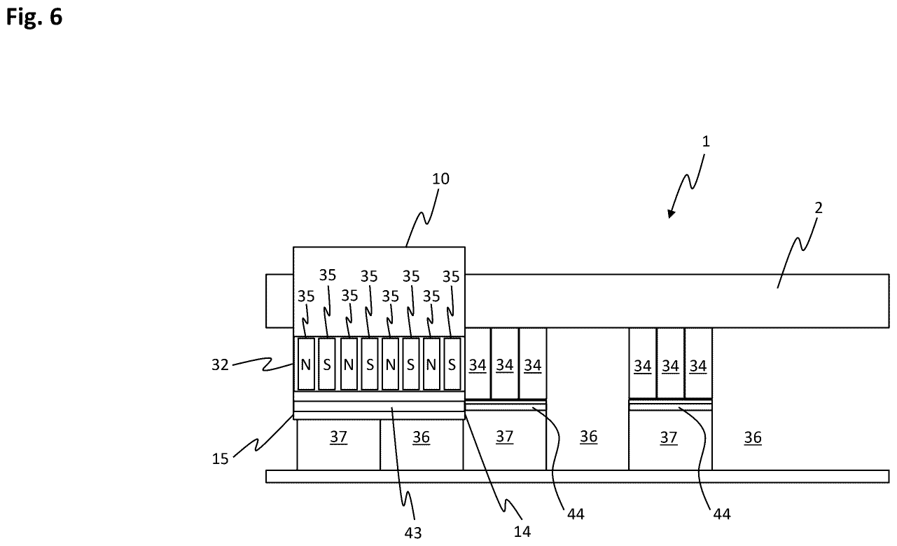

FIG. 6 shows a side view of a further linear transport system 1, which corresponds to the linear transport system 1 of FIGS. 1 to 5, unless differences are described below. The movable unit 10 comprises a position magnet element 43 having position magnets which are arranged below the magnets 35 of the rotor 32.

The position magnet element 43 is mounted opposite to the motor module elements 37. Magnetic sensor elements 44 are arranged at the relevant position of the motor module elements 37. The magnetic sensor elements 44 may be used to evaluate a magnetic field of the position magnet element 43 in order to determine a rotor position. The movable unit 10 also comprises a front end 14 and a rear end 15. The magnetic sensor elements 44 may in particular comprise Hall sensors, for example 3D Hall sensors.

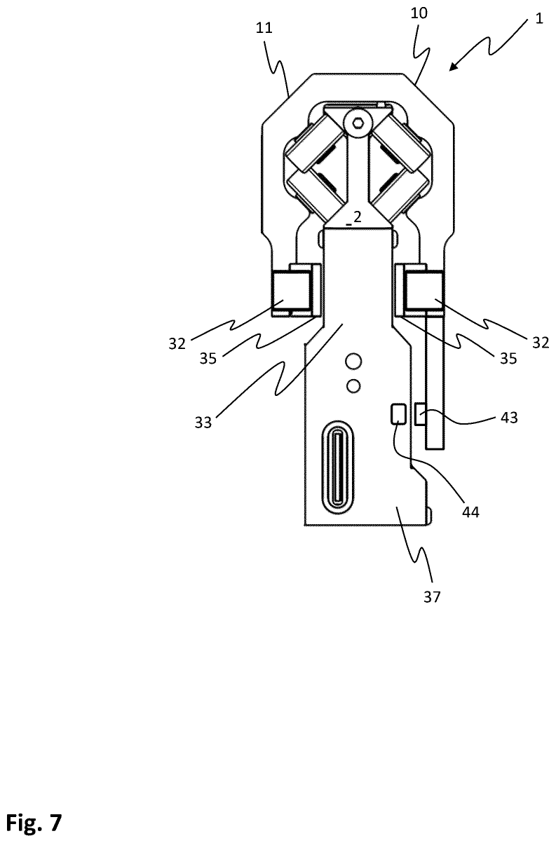

FIG. 7 shows a cross-section through the linear transport system 1 of FIG. 6. The linear transport system 1 according to FIG. 7 is essentially constructed in the same way as the transport system 1 according to FIG. 3, so that only the differences are discussed in this context.

The position magnet element 43 is arranged opposite to the magnetic sensor element 44. It may be provided that the magnetic sensor element 44 is arranged in the motor module element 37 in such a way that interference of the magnetic sensor element 44 by the magnets 35 is minimized, for example by the magnetic sensor element 44 being arranged at a distance from the magnets 35.

In an example embodiment, the magnetic sensor element may also be used to evaluate a magnetic field 40 of the magnets 35 in order to determine the position of the rotor 32 or of the movable unit 10, respectively. It may also be provided that the position magnet element 43 is encoded. This means that the position magnets of the position magnet element 43 may have different properties over the length of the rotor 32, so that a more precise determination of the position of the rotor 32 is possible. In particular, measured magnetic fields or magnetic field vectors in a magnetic sensor element 44 may therefore differ in the axes of the various magnetic fields which generate the multiple magnetic field sensors that form a magnetic sensor element 44.

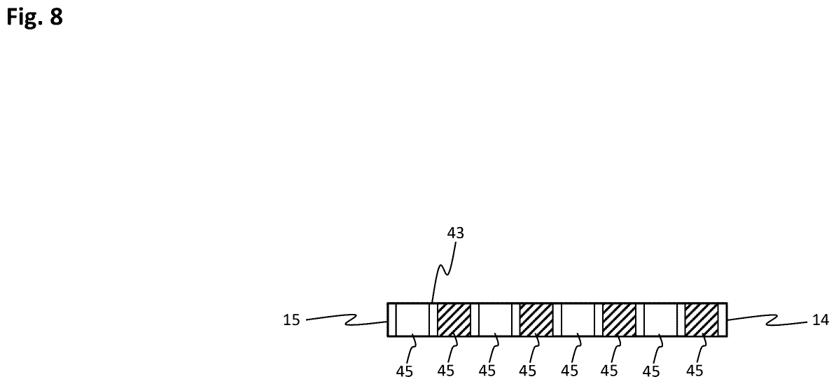

FIG. 8 shows a view of a position magnet element 43 with position magnets 45. The position magnets 45 are alternately embodied as N-pole and S-pole. For better differentiation, the S poles are shown hatched in FIG. 8. Determining the position having such a position magnet element 43 essentially corresponds to determining the position using the magnets 35 of the rotor. This may have the advantage that the position magnets 45 do not interact with the drive magnetic field of the drive coils 33 and thus the magnetic field generated by the position magnets 45 is not influenced by the energization of the drive coils 33. Furthermore, the position magnets 45 have no influence on the driving behaviour of the movable unit 10, since interaction with the drive coils 33 or magnets 35 is minimized.

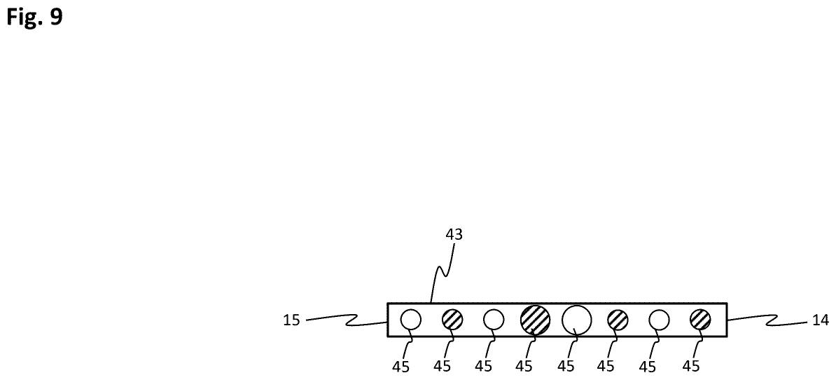

FIG. 9 shows a view of a further position magnet element 43, in which the central position magnets 45 have a larger magnetic field compared to the outer position magnets 45. The position magnets 45 of the movable unit 10 thus comprise different magnetic field strengths. For a better differentiation, the S poles are also shown to be hatched in FIG. 9. In an example embodiment, it may be provided that the central position magnets 45 comprise a smaller magnetic field compared to the outer position magnets 45.

In this case, as well, the position magnets 45 of the movable unit 10 comprise different magnetic field strengths. For this reason, particularly the position magnets 45 at the front end 14 or at the rear end 15 of the movable unit 10 comprise a different magnetic field strength than position magnets 45 between the front end 14 and the rear end 15. This makes it possible to detect the front end 14 or the rear end 15 of the movable unit 10 with the aid of the magnetic sensor element 44. The different magnetic field strength may be achieved via a different size, but also via a choice of material for the position magnets 45. This configuration allows for clearly determining the position of the rotor.

The position magnet elements 45 of FIGS. 8 and 9 have the same length as the rotor 32.

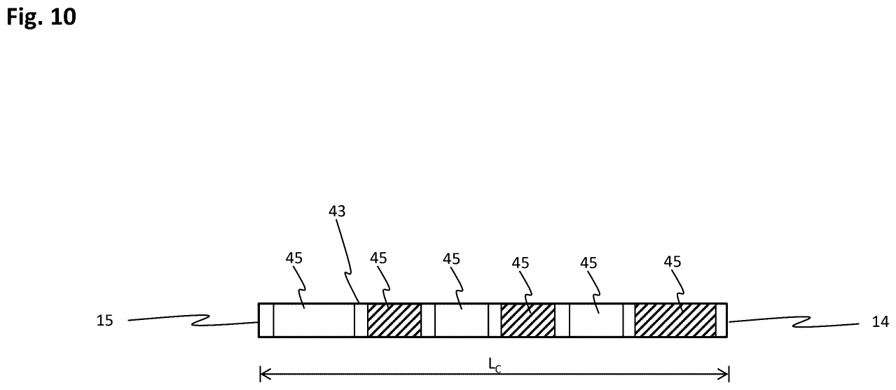

FIG. 10 shows a view of a further position magnet element 43, in which the position magnets 45 are extended at the front end 14 or the rear end 15 of the movable unit 10 as viewed in relation to a direction of movement. For a better differentiation, the S-poles are also shown to be hatched in FIG. 10. In particular, the position magnet clement 43 may be longer than the rotor 10.

This also allows for recognizing the front end 14 or the rear end 15 of the movable unit 10 with the aid of the magnet sensor element 44. In particular, a magnetic sensor element length L_{C} is therefore larger than the motor module length L_{M}. The larger position magnets 45 generate a different magnetic vector field. This may then be distinguished from the geometrically different (shorter) position magnets 45 by measuring with the magnetic field sensors. The number of different position magnets 45 may be arbitrary and the position of the distinguishable position magnets 45 within the position magnet element 43 may also be chosen arbitrarily. For example, the second position magnet 45 may also be different, or the third, etc.

The embodiments shown in FIGS. 8 to 10 may be advantageous in particular because a lower magnetic field is sufficient for the position magnets 45 compared to the magnets 35 of the rotor 32 and thus manufacturing costs may be saved if necessary.

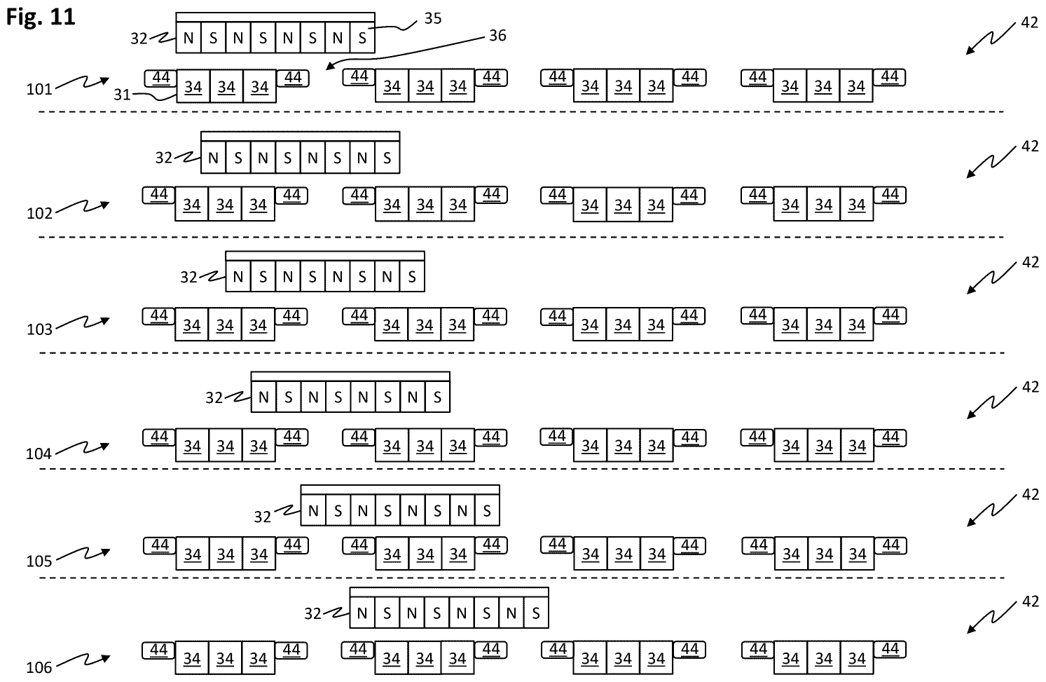

FIG. 11 shows a first view 101, a second view 102, a third view 103, a fourth view 104, a fifth view 105 and a sixth view 106 of a linear motor diagram 42 of a linear motor 30 of a linear transport system 1, which corresponds to the linear motor diagram 42 of FIG. 5, unless differences are described below.

A magnetic sensor element 44 is arranged below the motor modules 33 and thus concealed by the motor modules 33 in this depiction, as in FIGS. 6 and 7. The magnetic sensor element 44 protrudes above the respective motor module 33. As a result, the motor module element 37 is enlarged in the direction of movement of the rotor 32. This allows for determining the position of the rotor 32 more precisely, as magnetic field sensors of different magnetic sensor element e 44 may detect the magnetic field 40 of the rotor 32 or the magnets 35, particularly in the fifth view 105 and in the sixth view 106.

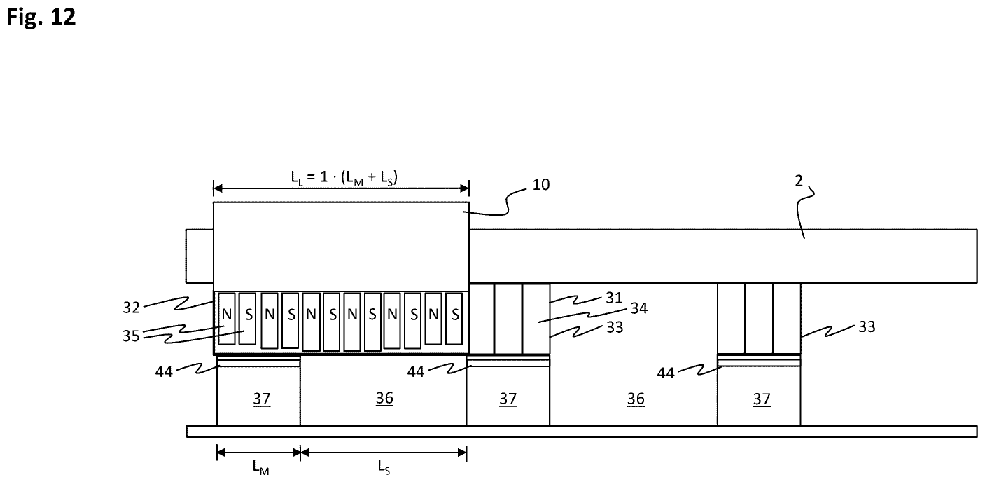

FIG. 12 shows a side view of a further linear transport system 1, which corresponds to the linear transport system of FIGS. 1 to 5, unless differences are described below. Here, on the one hand, the gap length L_{S} is different from that in the example embodiment of FIGS. 1 to 5 and, on the other hand, the magnets 35 are different. Both differences may also be provided individually.

The gap length L_{S} is a multiple of the motor module length L_{M}. In particular, the gap length L_{S} corresponds to twice the motor module length L_{M}. This means that only a third of the motor modules 33 are required compared to a conventional linear transport system 1. The rotor 32 comprises twelve magnets 35, so that the increased gap 36 is compensated for by a larger number of magnets 35. The magnets 35 or the rotor 32 may again be arranged on both sides of the motor module 33 as shown in FIG. 4.

In addition, FIG. 12 shows that the magnets 35 of the rotor 32 have different extensions in a direction perpendicular with regard to the guide rail 2. Based on the different extension of the magnets 35, conclusions may be drawn about the rotor position. In particular, a magnetic field determined by a magnetic sensor element 44 may be different depending on the rotor position due to the different extension, thus allowing for determining the position. In particular, it may be provided that the extension of the magnets 35 results in the magnets 35 also being arranged outside of an overlap with the drive coils 34, so that driving characteristics are influenced as little as possible.

In an example embodiment, the magnets 35 comprise a different relative position to the magnetic sensor element 44 due to the different extension perpendicular to the guide rail 2. This may be achieved, for example, by providing a different overlap with the magnetic sensor clement 44. This allows for a particularly precise position determination. As an alternative to the magnetic sensor element 44, individual magnetic sensors, in particular Hall sensors or 3D Hall sensors, may also be arranged.

A suitable magnetic field sensor, for example a 3D Hall sensor, may be used to measure a difference in the magnetic field between the differently embodied magnets 35, particularly perpendicular to the guide rail 2. This also makes it possible to uniquely determine and identify the absolute position of a rotor 32 (analogous to the fifth view 105 or the sixth view 106 of FIG. 5). In FIG. 12, only magnets 35 having three different lengths are shown; of course, there may also be more than three or only two different geometric designs.

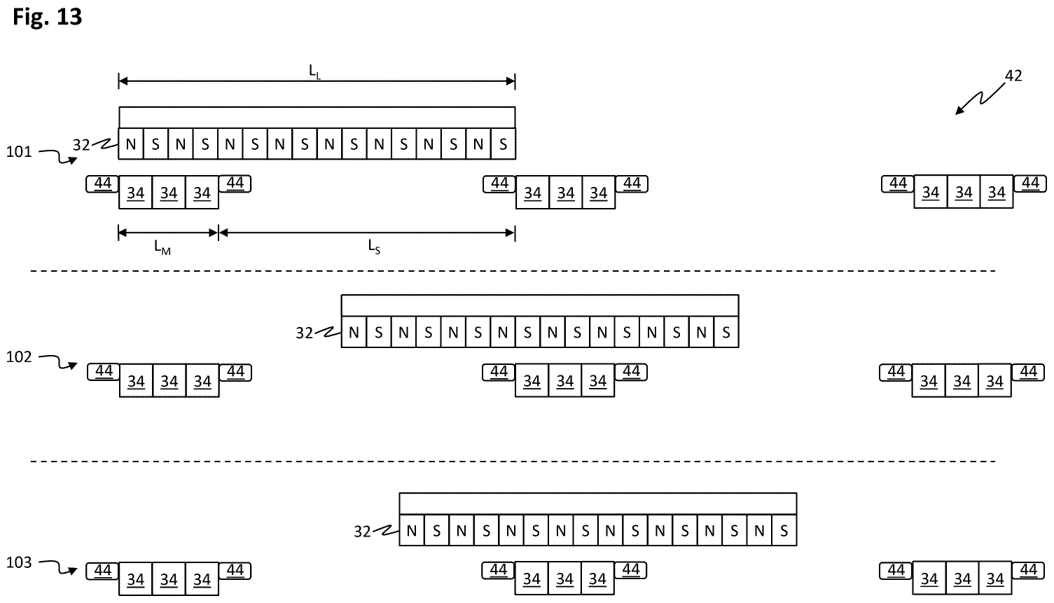

FIG. 13 shows a first view 101, a second view 102 and a third view 103 of a linear motor scheme 42 of a linear motor 30 of a further linear transport system 1, which corresponds to the linear motor scheme 42 of FIG. 5, unless differences are described below. In this example embodiment, the gap length L_{S} corresponds to three times the motor module length L_{M}. In this case, a fourth of the motor modules 33 is required compared to a conventional linear transport system. In this embodiment, it may be provided that the rotor 32 comprises sixteen magnets 35, so that the enlarged gap 36 is also compensated for by a larger number of magnets 35. In this way, a particularly cost-effective and resource-saving linear transport system 1 may be provided.

In the example embodiment of FIG. 13, the magnetic sensor elements 44 are also longer than the motor modules 33. This may be provided analogously to the linear motor scheme 42 of FIG. 11. Furthermore, both in the embodiment of FIG. 11 and in the embodiment of FIG. 13, magnetic sensors or magnetic sensor elements 44 may also be provided within the gap 36 in order to achieve a more precise position determination. In particular, the entire gap 36 may also be equipped with magnetic sensors or magnetic sensor elements 44. In particular, the magnetic sensor elements 44 may project beyond the motor modules 33 on both sides by twice the distance A_{M} between two magnet centers.

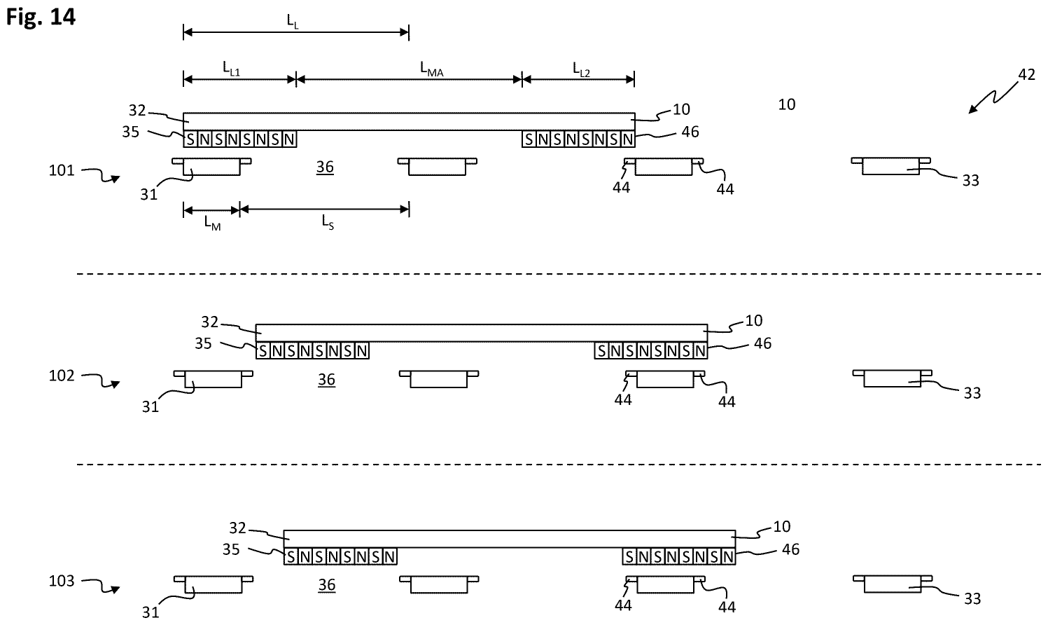

FIG. 14 shows a first view 101, a second view 102 and a third view 103 of a linear motor diagram 42 of a linear motor 30 of a further linear transport system 1, which corresponds to the linear motor diagram 42 of FIG. 13, unless differences are described below. The individual drive coils 34 in the stators 31 of the motor modules 33 are shown above. The magnets 35 of the rotor 32 are arranged in two magnetic elements 46. A plurality of magnets 35 are arranged in each of the magnet elements 46, in the example embodiment of FIG. 14 eight magnets 35 in each case. However, a different number of magnets 35 per magnet element 46 may also be provided.

The rotor length L_{L} is a sum of magnetic element lengths L_{L1}, L_{L2} of the magnetic elements 46. One of the magnetic elements 46 has a first magnetic element length L_{L(L1)}, the other magnetic element 46 has a second magnetic element length L_{L2}. The magnetic element lengths L_{L1}, L_{L2} may be identical or different.

The magnetic elements 46 are arranged at a distance from one another. A magnetic element spacing L_{MA} may in particular correspond to the rotor length L_{L}. Thus, for the movable element 10 in the embodiment according to FIG. 14, a total length results from the sum of the first magnetic element length L_{L1}. magnetic clement spacing L_{MA} and the second magnetic element length L_{L2}. By arranging the magnets 35 in two magnetic elements 46, a more flexible arrangement of the linear transport system 1 is possible.

In this example embodiment, the gap length L_{S} may again correspond to three times the motor module length L_{M}. The rotor length L_{L} may be the sum of the gap length L_{S} and the motor module length L_{M}, where the magnetic element lengths L_{L1}, L_{L2} each correspond to half the rotor length L_{L}.

In this example embodiment, it is also possible to embody the magnetic sensor elements 44 to be longer than the motor modules 33 in order to improve position measurement, as described, for example, in connection with FIG. 13. As an alternative or in addition, it is also possible to provide position magnets 45 in the area between magnetic elements 46 in order to improve the accuracy of the position determination.

It may be necessary to provide increased drive force in certain areas of the linear transport system 1. This may be achieved in particular by increasing the number of drive coils 34 in these areas.

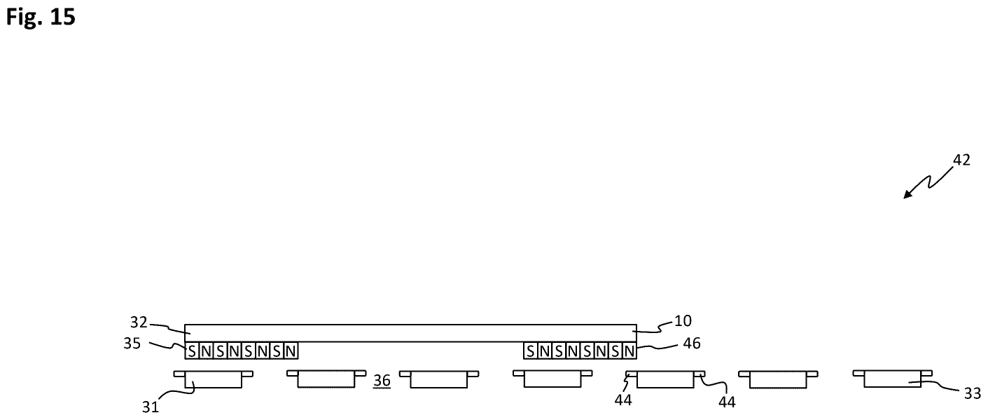

FIG. 15 shows a linear motor diagram 42 of a linear motor 30 of a further linear transport system 1, which corresponds to the linear motor diagram 42 of FIG. 14, unless differences are described below. A further motor module 33 is arranged between each of the motor modules 33 shown in FIG. 14. As a result, not four of the magnets 35 are arranged in the area of the motor modules 33 as in FIG. 14, but eight of the magnets 35, so that a drive force may be doubled by this arrangement.

It may be provided that the linear transport system 1 comprises a first area with the linear motor scheme 42 of FIG. 14 and a second area with the linear motor scheme 42 of FIG. 15. A change between the first area and the second area may take place at a point of the linear transport system 1 at which a jolt or a latch has a minor effect. For example, the movable unit 10 may be transported in the first area and an object arranged on the movable unit 10 may be processed in the second area, so that a larger drive force is available in the second area, which may be necessary when processing the object. The movable unit 10 may be moved constantly within each of the areas and, as the case may be, a jolt only occurs at the transition between the areas due to the different gaps 36 or gap lengths L_{S}. This may be less problematic at this point than during processing of the object.

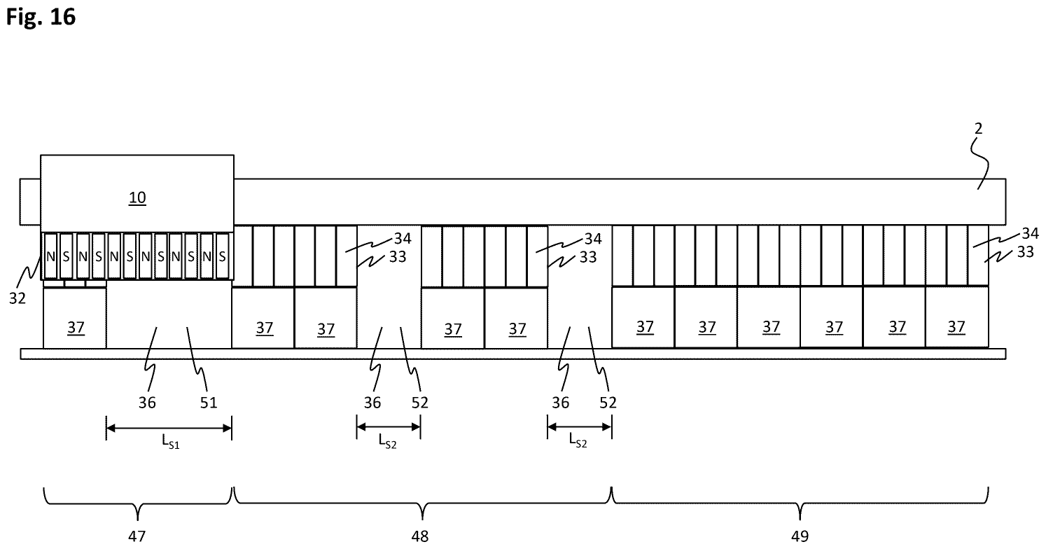

FIG. 16 shows a side view of a further linear transport system 1, which corresponds to the linear transport system 1 of FIG. 6, unless differences are described below. As in the example embodiment of FIG. 12, the rotor 32 comprises twelve magnets 35.

In a first region 47, the gap 36 is a first gap 51 and the gap length L_{S} is a first gap length L_{S1}. The first gap length L_{S1} is twice the motor module length L_{M}. In a second region 48, a second gap 52 is arranged between the motor modules 33. The second gap 52 has a second gap length L_{S2}. The second gap length L_{S2} is the single motor module length L_{M}.

The first gap length L_{S1} and the second gap length L_{S2} are therefore different. This makes it possible, for example, for different drive magnetic fields to be generated in the first area 47 and in the second area 48, which may differ in particular with regard to a magnetic field strength. As a result, a linear transport system 1 may be provided in which, for example, an increased drive magnetic field and thus a larger drive force may be provided in the second area 48 compared to the first area 47. The first area 47 may then be suitable for transport, for example, and the drive magnetic field in the first area 47 may be sufficient for transport, while in the second area 48, processing and/or acceleration of an object arranged on the movable unit 10 requires an increased drive magnetic field.

With the aid of this configuration, motor modules 33 may therefore still be saved and an increased drive magnetic field may still be provided in partial areas of the linear transport system 1. FIG. 16 also shows a third area 49 in which no gap 36 is provided between the motor modules 33. As a result, a further increased drive magnetic field or a further increased drive force may be provided in the third area 49. In each of the areas 47, 48, 49, the overlap of the magnets 35 to the motor modules 33 remains the same, so that there is no larger latch. Latching therefore only occurs at the transition between the areas 47, 48, 49.

It is also possible to increase the force upon a rotor 32 by arranging a plurality of motor modules 33 next to one another in relation to the direction of the guide rail 2. The motor modules 33 may be arranged in parallel to other motor modules 33 or in parallel to a gap 36. The magnets 35 of the rotor 32 may be longer transverse to the direction of travel, i.e. transverse to the guide rail 2, so that they may generate an increased force with the parallel motor modules 33. Alternatively, the rotor 32 may also have further additional magnets analogous to the magnets 35, which are arranged in parallel or offset in parallel.

In the example shown in FIG. 16, the first gap length L_{S1} corresponds to n times, in this case twice, the motor module length L_{M}. The second gap length L_{S2} corresponds to n times, in this case exactly to, the motor module length L_{M} reduced by one. Of course, multiples other than the n-fold selected in FIG. 16 may also be selected here. For example, the first gap length L_{S1} may correspond to three times the motor module length L_{M}. The second gap length L_{S2} may then correspond to twice the motor module length L_{M}.

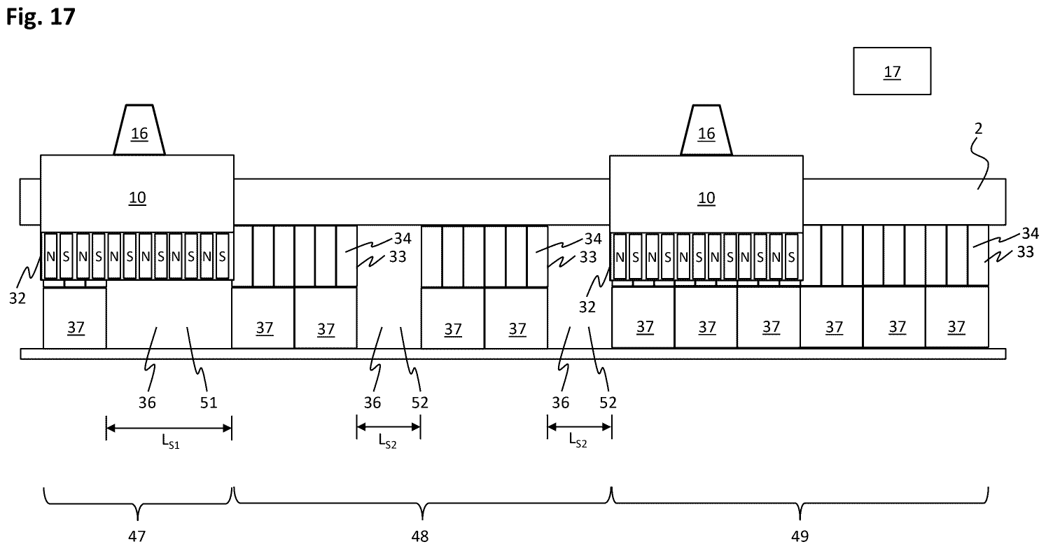

FIG. 17 shows a side view of a linear transport system 1 as shown in FIG. 16. In contrast to the depiction of FIG. 16, FIG. 17 shows two movable units 10, on each of which an object 16 is arranged. One of the movable units 10 is located in the first area 47, the other movable unit 10 in the third area 49. An object processing station 17 above the third area 49 may be used to process the object 16. Increased force may be required for processing the object 16, for example if the object processing station 17 is used for machining the object 16.

The first region 47 described in connection with FIGS. 16 and 17, the second region 48 described in connection with FIGS. 16 and 17 and the third region 49 described in connection with FIGS. 16 and 17 may also be used in the spaced-apart magnetic elements 46 of the rotor 32 described in connection with FIGS. 14 and 15.

In an example embodiment, the first gap length L_{S1} corresponds to n times the motor module length L_{M}. The second gap length L_{S2} corresponds to n times the motor module length L_{M} reduced by two. This results in savings in the number of motor modules 33 while at the same time increasing the drive magnetic fields in the second area 48.

In an example embodiment, the first gap length L_{S1} corresponds to three times the motor module length L_{M}. The second gap length L_{S2} corresponds to the motor module length L_{M}. In particular, this means that the first gap length L_{S1} provided in the first area 47 may initially also be provided in the second area 48 when the linear transport system 1 is constructed and then a further motor module 33 is placed centrally in the first gap 51 in the second area 48, so that the second gap length L_{S2} is configured. In this way, a simple structure of the linear transport system 1 may be achieved.

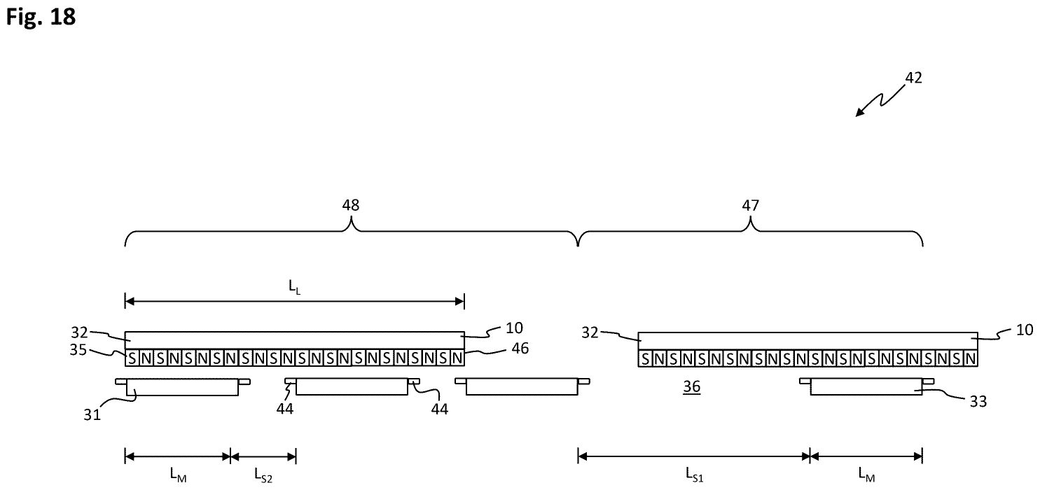

FIG. 18 shows a linear motor diagram 42 of a linear motor 30 of a further linear transport system 1, which corresponds to the linear motor diagram 42 of FIGS. 14 and 15, unless differences are described below. Here too, a first area 47 having a first gap length L_{S1} and a second area having a second gap length L_{S2} are provided.

The rotor 32 comprises twenty-four magnets 35. The motor modules 33 comprise six drive coils 34. The rotor length L_{L} corresponds to twenty-four times the distance A_{M} between two magnet centers. The motor module length corresponds to six times the distance A_{S} between two drive coil centers. In the first area 47, the first gap length L_{S1} corresponds to twice the motor module length L_{M}. This results in the relation for the rotor length L_{L}:

$${L}_{L} = {L}_{M} + {L}_{S 1}$$

In the second area 48, the second gap length L_{S2} corresponds to half the motor module length L_{M}. This results in the relation for the rotor length L_{L}:

$${L}_{L} = 2 ( {L}_{M} + {L}_{S 2} )$$

Both in the first area 47 and in the second area 48, the linear transport system 1 therefore fulfills the relation according to the invention, which specifies that the rotor length L_{L} corresponds to n times the sum of the motor module length L_{M} and the gap length L_{S}.

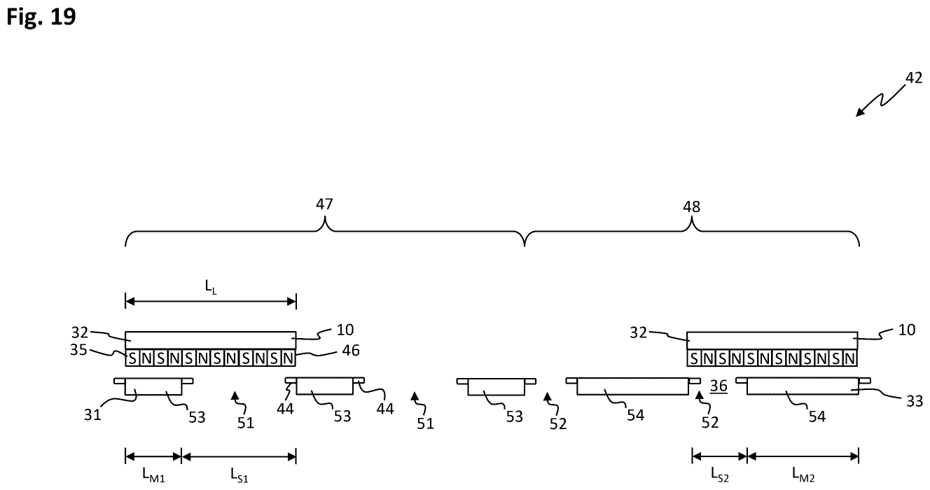

FIG. 19 shows a linear motor diagram 42 of a linear motor 30 of a further linear transport system 1. A first motor module 53 is arranged in a first area 47, which has a first motor module length L_{M1}. A first gap 51 with a first gap length L_{S1} is embodied between the first motor modules 53.

A second motor module 54, which comprises a second motor module length L_{M2}, is arranged in a second region 48. A second gap 52 with a second gap length L_{S2} is formed between the second motor modules 54. The first gap length L_{S1} corresponds to twice the first motor module length L_{M1}. The second gap length L_{S2} corresponds to half the second motor module length L_{M2}. The second motor module length L_{M2} is twice as long as the first motor module length L_{M1}. This results in the rotor length L_{L}:

$${L}_{L} = {L}_{M 1} + {L}_{S 1} = {L}_{M 2} + {L}_{S 2} .$$

The relation according to the invention, which specifies that the rotor length L_{L} corresponds to n times the sum of the motor module length L_{M} and the gap length L_{S}, is therefore fulfilled both in the first range and in the second range. In general, it may be provided that for the rotor length L_{L}:

$${L}_{L} = n ( {L}_{M 1} + {L}_{S 1} ) = m ( {L}_{M 2} + {L}_{S 2} ) ,$$

where n and m are natural numbers.

In this example embodiment, shorter and therefore more cost-effective motor modules 33 may therefore be provided in the first area 47, while longer motor modules 33 are suitable for providing an increased drive force in the second area 48.

Further embodiments of the linear transport system 1 are also conceivable, in which the relation according to the invention, which specifies that the rotor length L_{L} corresponds to n times the sum of the motor module length L_{M} and the gap length L_{S}, is fulfilled in each case.

In addition to the embodiments shown, in which the guide rail 2 is linear, provision may also be made to arrange the motor modules 33 with a gap length L_{S} between the motor modules 33 in such a way that the movable unit 10 may travel along a curve along a curved guide rail 2. For example, horizontal, but also vertical curves with uniform, almost rectangular motor modules 33 would be possible. The motor module elements 37 could then be arranged at a distance from each other and each drive the rotor 32.

In the case of a horizontal curve, the curve radius would be in parallel to an air gap plane between motor modules 33 and rotor 32 and the condition L_{L}=n(L_{M}+L_{S}) is met in particular for the center of the drive coils 35 of motor module 33 and a medium radius.

In a vertical curve, the gap 36 between the motor modules 33 lies on a secant of the circular arc. The curve radius is perpendicular with regard to the gap 36 between the motor modules 33. The circular arc is formed by a plurality of straight secants from uniform rectangular motor modules 33. The condition L_{L}=n(L_{M}+L_{S}) is met on the secant. However, for a large curve radius and comparatively short motor modules 33 and small gap lengths L_{S}, the deviation between the circular arc and the secant may be negligible.

This invention has been described with respect to exemplary examples. It is understood that changes can be made and equivalents can be substituted to adapt these disclosures to different materials and situations, while remaining with the scope of the invention. The invention is thus not limited to the particular examples that are disclosed, but encompasses all the examples that fall within the scope of the claims.

TABLE 1
List of reference numerals

1 linear transport system
2 guide rail
3 controller
4 data line
5 running surfaces
10 movable unit
11 housing
12 legs
13 running roller
14 front end
15 rear end
16 object
17 object processing station
30 linear motor
31 stator
32 rotor
33 motor module
34 drive coils
35 magnet
36 gap
37 motor module element
38 coil core
39 connection
40 magnetic field
41 coil magnetic field
42 linear motor diagram
43 position magnet element
44 magnetic sensor element
45 position magnet
46 magnetic element
47 first area
48 second area
49 third area
51 first gap
52 second gap
53 first motor module
54 second motor module
101 first view
102 second view
103 third view
104 fourth view
105 fifth view
106 sixth view
A_{M} distance between two magnet centers
A_{S} distance between two drive coil centers
L_{A} drive coil length
L_{B} magnet length
L_{C} magnetic sensor element length
L_{L} rotor length
L_{L1} first magnetic element length
L_{L2} second magnetic element length
L_{MA} magnetic element distance
L_{M} motor module length
L_{M1} first motor module length
L_{M2} second motor module length
L_{S} gap length
L_{S1} first gap length
L_{S2} second gap length

What is claimed is:

1. A linear transport system comprising:
a movable unit,
a guide rail for guiding the movable unit, and
a linear motor for driving the movable unit along the guide rail;
wherein the linear motor comprises a stator and a rotor, the stator comprising a plurality of motor modules which are arranged in a stationary manner along the guide rail and each comprise a plurality of drive coils, and
the rotor being arranged on the movable unit and comprising a plurality of magnets;
the motor modules having a motor module length, the motor module length corresponding to a distance between two drive coil centers multiplied by a number of drive coils per motor module;
wherein a gap is arranged between at least two of the motor modules, the gap having a gap length, and
wherein the gap length corresponds at least to the motor module length.

2. The linear transport system according to claim 1, wherein the distance between two drive coil centers is not equal to the distance between two magnet centers.

3. The linear transport system according to claim 1, wherein:
the rotor having a rotor length, the rotor length corresponding to a distance bet ween two magnet centers multiplied by a number of magnets of the rotor, and
wherein the rotor length corresponds at least to the sum of the motor module length and the gap length.

4. The linear transport system according to claim 3, wherein the rotor length is a multiple of the sum of the motor module length and the gap length.

5. The linear transport system according to claim 1, wherein the gap length is a multiple of the motor module length.

6. The linear transport system according to claim 1, wherein:
in a first region the gap is a first gap and the gap length is a first gap length,
wherein a second gap is arranged in a second region between two of the motor modules,
wherein the second gap has a second gap length, and
wherein the first gap length and the second gap length differ from each other.

7. A linear transport system comprising:
a movable unit,
a guide rail for guiding the movable unit, and
a linear motor for driving the movable unit along the guide rail and a controller;
wherein the linear motor comprises a stator and a rotor, the stator comprising a plurality of motor modules which are arranged in a stationary manner along the guide rail and each comprise a plurality of drive coils, and
the rotor being arranged on the movable unit and comprising a plurality of magnets;
wherein a gap is arranged between at least two of the motor modules, the gap having a gap length;
wherein the controller is configured to issue control commands to the motor modules and the motor modules are configured to energize the drive coils on the basis of the control commands, and
wherein the controller issues control commands so that the movable unit carries out a predetermined movement along the guide rail and wherein the controller recognizes installation-related deviations in gap length on the basis of the predetermined movement takes them into account for the output of further control commands.

8. The linear transport system according to claim 7, wherein:
the motor modules are arranged in motor module elements,
wherein the motor module elements further comprise a magnetic sensor element, and
wherein a magnetic field of the movable unit is measured by the magnetic sensor element and a rotor position is determined therefrom.

9. The linear transport system according to claim 8, wherein:
the magnetic sensor element has a magnetic sensor element length, and
wherein the magnetic sensor element length is larger than the motor module length.

10. The linear transport system according to claim 8, wherein:
a magnetic field of the magnets of the rotor is measured by the magnetic sensor element, and
wherein the magnets of the rotor have different extensions in a direction perpendicular to the guide rail.

11. The linear transport system according to claim 8, wherein a magnetic field of position magnets of the movable unit is measured by the magnetic sensor element.

12. The linear transport system according to claim 11, wherein the position magnets of the movable unit comprise different magnetic field strengths.

13. The linear transport system according to claim 7, wherein:
in a first region the gap is a first gap and the gap length is a first gap length,
wherein a second gap is arranged in a second region between two of the motor modules,
wherein the second gap has a second gap length, and
wherein the first gap length and the second gap length differ from each other.

14. A linear transport system comprising:
a movable unit,
a guide rail for guiding the movable unit, and
a linear motor for driving the movable unit along the guide rail;
wherein the linear motor comprises a stator and a rotor, the stator comprising a plurality of motor modules which are arranged in a stationary manner along the guide rail and each comprise a plurality of drive coils, and
the rotor being arranged on the movable unit and comprising a plurality of magnets;
the motor modules having a motor module length, the motor module length corresponding to a distance between two drive coil centers multiplied by a number of drive coils per motor module;
wherein a gap is arranged between at least two of the motor modules, the gap having a gap length,
wherein the gap is a first gap in a first region and the first gap has a first gap length,
wherein a second gap is arranged in a second region between two of the motor modules, wherein the second gap has a second gap length, and
wherein the first gap length and the second gap length differ from each other.

15. The linear transport system according to claim 14, wherein the distance between two drive coil centers is not equal to the distance between two magnet centers.

16. The linear transport system according to claim 14, wherein:
the rotor having a rotor length, the rotor length corresponding to a distance bet ween two magnet centers multiplied by a number of magnets of the rotor, and
wherein the rotor length corresponds at least to the sum of the motor module length and the gap length.

17. The linear transport system according to claim 16, wherein the rotor length is a multiple of the sum of the motor module length and the gap length.

18. The linear transport system according to claim 14, wherein the gap length corresponds at least to the motor module length.

19. The linear transport system according to claim 14, wherein the gap length is a multiple of the motor module length.
